(19) United States
(12) Patent Application Publication
(10) Pub. No.: US 2016/0378630 A1
(43) Pub. Date: Dec. 29, 2016

(54) PORT MONITORING SYSTEM

(71) Applicant: Dell Products L.P., Round Rock, TX (US)

(72) Inventors: Padmanabhan Narayanan, Adyar (IN); Sudharsan Dhamal Gopalarathnam, Chennai (IN)

(21) Appl. No.: 14/750,764

(22) Filed: Jun. 25, 2015

(51) Int. Cl. G06F 11/30; G06F 11/32

(52) U.S. Cl. CPC G06F 11/3048; G06F 11/324

(57) ABSTRACT

A port monitoring system includes a networking device that includes a device port and a monitoring device that includes a display. The networking device captures port indicator data that is associated with the operation of the device port, timestamps the port indicator data, and wirelessly transmits the port indicator data to the monitoring device. The monitoring device wirelessly receives the port indicator data from the networking device and determines whether the timestamp on the port indicator data satisfies a timing requirement for displaying a port indication. If the timestamp satisfies the timing requirement, the monitoring device provides a graphical user interface on the display that includes a graphical port indicator that operates according to the port indicator data. As such, real-time isochronous port indicator data may be wirelessly transmitted and displayed graphically on a monitoring device that allows a user to easily monitor port indicators on networking devices.

### BACKGROUND

The present disclosure relates generally to information handling systems, and more particularly to a monitoring system for ports on an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, switches, typically include a plurality of ports (e.g., 48 ports for a 1 rack unit (RU) switch), and each of those ports may have a port indicator associated with it. For example, the switch may provide a fixed port number adjacent each port (e.g., printed on the silkscreen), as well as one or more Light Emitting Devices (LEDs) adjacent each port to provide for the indication of link state, activity, and/or other operating information about that port. The switches may be positioned in racks in a datacenter to provide for the routing of data between servers and/or storage systems. With conventional racks being up to 7 feet tall, and 9 foot tall racks having been introduced in recent years, visual access to the LEDs on the switch has been comprised, limiting the ability for users to monitor the LEDs. For example, a user may have difficulty visually inspecting the LEDs on switches at the bottom and/or top of the rack due to the height of the rack, viewing angles to the LEDs being blocked by transceivers and cabling, and/or for a number of other issues known in the art. In addition, LEDs on conventional switches are relatively limited in the different types of information they can display about a port, which limits their use during different stages of switch use (e.g., as a diagnostic tool during manufacture, for use once deployed, etc.)

Accordingly, it would be desirable to provide an improved port monitoring system.

### SUMMARY

According to one embodiment, an information handling system (IHS) includes a display device; a wireless communication subsystem; a processing system that is coupled to the display device and the wireless communication device; and a memory system that is coupled to the processing system and that includes instructions that, when executed by processing system, cause the processing system to provide a port monitoring engine that is configured to: receive, from a networking device using the wireless communication subsystem, port indicator data that is associated with the operation of a device port on the networking device; determine that a timestamp on the port indicator data satisfies a timing requirement for displaying a port indication; and provide, on the display device in response to the timestamp on the port indicator data satisfying the timing requirement, a graphical user interface that includes a graphical port indicator that operates according to the port indicator data.

### BRIEF DESCRIPTION OF THE DRAWINGS

FIG. 1 is a schematic view illustrating an embodiment of an information handling system.

FIG. 2 is a schematic view illustrating an embodiment of a port monitoring system.

FIG. 3 is a schematic view illustrating an embodiment of a networking device used in the port monitoring system of FIG. 2.

FIG. 4 is a schematic view illustrating an embodiment of a monitoring device used in the port monitoring system of FIG. 2.

FIG. 5 is a flow chart illustrating an embodiment of a method for monitoring ports.

FIG. 6 is a perspective view illustrating an embodiment of a user monitoring ports on networking devices in a datacenter.

FIG. 7 is a schematic view illustrating an embodiment of a wireless communication device and fan-out system coupled to the networking device of FIG. 3.

FIG. 8 is a screen shot illustrating the monitoring device of FIG. 4 displaying a device detection and selection screen.

FIG. 9 is a screen shot illustrating the monitoring device of FIG. 4 displaying a device monitoring screen.

FIG. 10 is a screen shot illustrating the monitoring device of FIG. 4 displaying a device monitoring screen.

FIG. 11 is a screen shot illustrating the monitoring device of FIG. 4 displaying a device monitoring screen.

FIG. 12 is a screen shot illustrating the monitoring device of FIG. 4 displaying a device monitoring screen.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

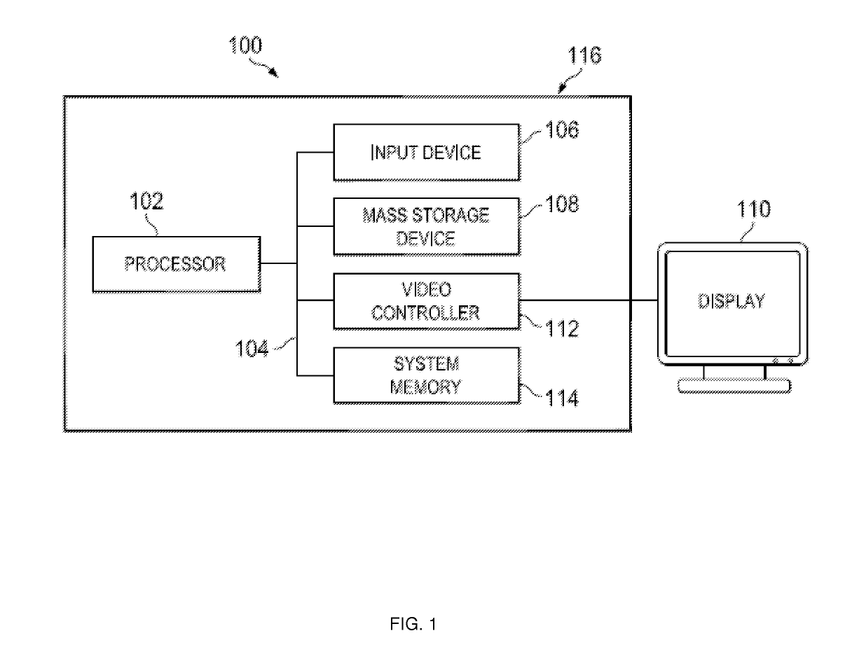

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

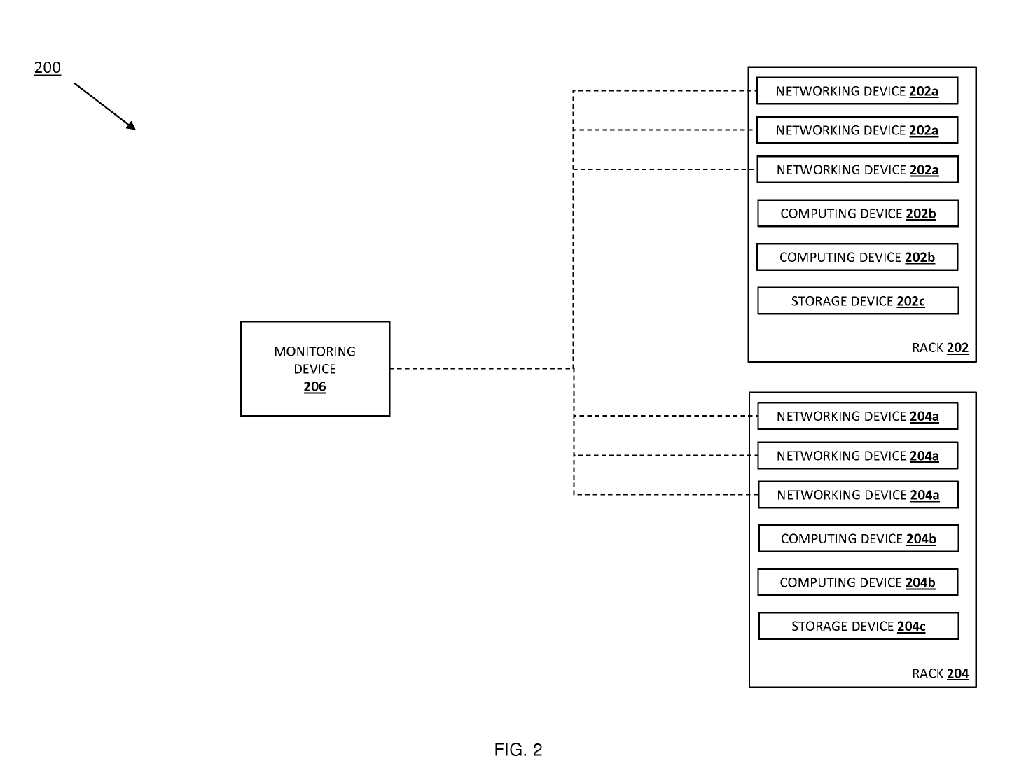

Referring now to FIG. 2, and embodiment of a port monitoring system 200 is illustrated. The port monitoring system 200 includes a plurality of racks 202 and 204. In an embodiment, the racks 202 and 204 may be any of a wide variety of racks known in the art for housing servers, storage systems, networking devices, and/or other computing systems known in the art. For example, the racks 202 and 204 may be conventional racks utilized in a data center as is known in the art. As such, while only two racks 202 and 204 are illustrated in FIG. 2, any number of racks may be utilized in the port monitoring system 200 while remaining within the scope of the present disclosure. The rack 202 houses a plurality of networking devices 202a (e.g., switches, routers, and/or other networking devices known in the art), a plurality of computing devices 202b (e.g., servers or other computing devices known in the art), and a storage device 202c (e.g., a storage area network (SAN) or other storage device known in the art). Similarly, the rack 204 houses a plurality of networking devices 204a, a plurality of computing devices 204b, and a storage device 204c. In the illustrated embodiment, a monitoring device 206 is coupled to the networking devices 202a and 204a. While a specific embodiment of the port monitoring system 200 is provided in FIG. 2 and discussed below, one of skill in the art in possession of the present disclosure will recognize that a wide variety of modification to the port monitoring system 200 will fall within the scope of the present disclosure. For example the monitoring device 206 is discussed below as a mobile device that wirelessly communicates with the networking devices 202a and 204a. However, the monitoring device 206 may be a relatively non-mobile device (e.g., a “desktop” computer) that may include a wired connection to the any of the devices in the racks 202 and 204 (e.g., the computing devices 202b and 204b; the storage devices 202c and 204c; etc.) in order to provide for the monitoring of the ports on those devices as is discussed below with the networking devices.

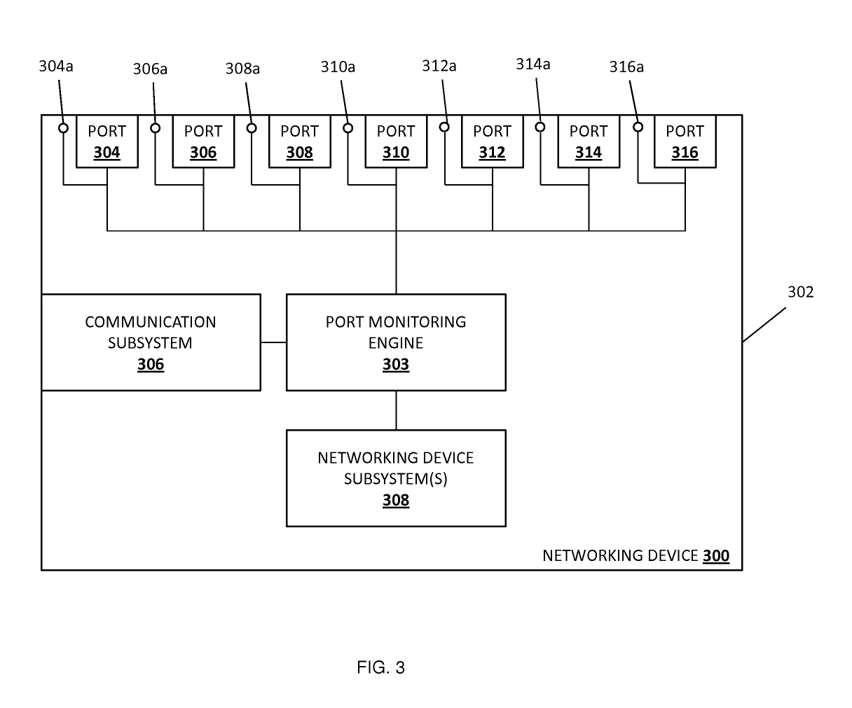

Referring now to FIG. 3, an embodiment of a networking device is illustrated. In an embodiment, the networking device 300 may be the IHS 100 discussed above with reference to FIG. 1 and/or may include some or all of the components of the HIS 100. In an embodiment, the networking device 300 may be any or all of the networking devices 202a and/or 204a discussed above with reference to FIG. 2. For example, the networking device 200 may be a switch, a router, and/or a variety of other networking devices known in the art. As such, the networking device 300 may include a variety of other networking components that are known in the art but not illustrated in FIG. 3 for clarity. In the illustrated embodiment, the networking device 300 includes a chassis 302 that houses the components of the networking device 300. For example, the networking device 300 includes a processing system that is housed in the chassis 302 (not illustrated, but which may be the processor 102 discussed above with reference to FIG. 1) and a memory system that is housed in the chassis 302 (not illustrated, but which may be the system memory 114 discussed above with reference to FIG. 1) and that includes instructions that, when executed by the processing system, cause the processing system to provide a port monitoring engine 303 that is configured to perform the functions of the port status engines and networking devices discussed below. The processing systems may include a central processing system (CPU), a network processing system (NPU), a graphics processing system (GPU), and/or other processing systems known in the art.

The networking device 300 also includes a plurality of device ports 304, 306, 308, 310, 312, 314, and 316 that may be housed in the chassis 302, accessible on an outer surface of the chassis 302, and/or other included in or on the chassis 302 in a variety of manners known in the art. While the device ports 304-316 are discussed below as Ethernet ports and optical/fiber ports, any of a variety of device ports known in the art are envisioned as falling within the scope of the present disclosure. Each of the ports 304-316 are illustrated as being coupled to the port monitoring engine 303 (e.g., via a coupling between the processing system and each of the ports 302-316). However, as discussed below, in some embodiments the port monitoring engine 303 may not be coupled to the ports 304-316. Each of the device port 304-312 may be associated with one or more respective device port indicators that are configured to indicate an operating status (or other information) about their associated device port. For example, in the illustrated embodiment, the device port 304 is associated with a device port indicator 304a, the device port 306 is associated with a device port indicator 306a, the device port 308 is associated with a device port indicator 308a, the device port 310 is associated with a device port indicator 310a, the device port 312 is associated with a device port indicator 312a, the device port 314 is associated with a device port indicator 314a, and the device port 316 is associated with a device port indicator 316a. In an embodiment, the device port indicators 304a-316a may be Light Emitting Devices (LEDs) and/or other device port indicators known in the art. However, in some embodiments, the device port indicators 304a-316a may be omitted (e.g., if the monitoring device discussed below is to be used exclusively to indicate the operation of the device ports, discussed in further detail below).

In an embodiment, each device port indicator may be positioned substantially adjacent its associated device port and, as such, may be housed in the chassis 302, accessible on an outer surface of the chassis 302, and/or otherwise included in or on the chassis 302 in a variety of manners known in the art. While only one device port indicator is illustrated as associated with each of the device ports in FIG. 3, one of skill in the art in possession of the present disclosure will recognize that more than one device port indicator may be provided in or on the chassis 302 in association with a device port while remaining within the scope of the present disclosure. Furthermore, while each of the device port indicators 304a-316a are illustrated as being coupled to the port monitoring engine 303 (e.g., via a coupling between the processing system and each of the device port indicators 302a-316a), in some embodiments the port monitoring engine 303 may not be coupled to the device port indicators 302a-316a. While only eight device ports and associated device port indicators are illustrated in FIG. 3, one of skill in the art in possession of the present disclosure will recognize that networking device may, and typically do, include many more device ports and device port indicators, and any number of device ports and device port indicators will fall within the scope of the present disclosure.

In conventional networking devices such as switches, device port indicators such as LEDs may be driven by a PHY in the device port, or by LED processors. For example, the LED processors may drive the LEDs in a variety of manners by determining various port states and driving a bit-stream (with a set of bits designated per device port) that drives the LEDs at an interval (typically 30 Hz for human eye cognition.) As discussed below, in some embodiments, that bit stream may be captured by the port monitoring system 303 and transmitted in real-time to a monitoring device to enable the functionality discussed below. However, such functionality may enable the removal of the actual LED port indicators from the switch, although the combined use of the LED port indicators on the switch and the functionality of the monitoring devices discussed below will fall within the scope of the present disclosure.

The networking device 300 also includes a communication subsystem 306 that is housed in the chassis 302 and coupled to the port monitoring engine 303 (e.g., via a coupling between the processing system and the communication subsystem 306). In the embodiments discussed below, the communication subsystem 306 is discussed as including a communication device (e.g., a Network Interface Controller (NIC)) that includes a communications port (e.g., a Universal Serial Bus (USB) port) that is configured to couple to a wireless communications adapter (e.g., directly, through a USB cable, etc.). However, in other embodiments the communications subsystem 306 may include an integrated wireless communication subsystem (e.g., a Bluetooth communication subsystem, a Near Field Communication (NFC) subsystem, a WiFi communication subsystem, and/or a variety of other wireless communication subsystems known in the art), a wired communication subsystem (e.g., where the communication port is configured to connect to a communication cable such as an Ethernet cable or a fiber optic cable), and/or a variety of other communication subsystems known in the art.

The networking device 300 also includes one or more networking device subsystems 308 that are housed in the chassis 302 and coupled to the port monitoring engine 303 (e.g., via a coupling between the processing system and the networking device subsystem(s) 308). As discussed below, the networking device subsystem(s) 308 may include subsystems that are configured to detect, generate, and/or otherwise provide port indicator data that is indicative of the operation of (or other information about) each of the device ports 304-316 and, in some embodiments, provide that port indicator data to the respective device port indicators 304a-316 associated with those device ports 304-316 (e.g., the PHYs or LED processors discussed above). While the coupling between the networking device subsystem(s) 308 and each of the device ports 304-316 and device port indicators 304a-316a is illustrated in FIG. 3 as being provided through the port monitoring engine 303 (e.g., when the port monitoring engine 303 operates to drive the device port indicators 304a-316a based on the operation of the device ports 304-316), in some embodiments, the networking device subsystem(s) 308 may be coupled to the device ports 304-316 (or included in the device ports 304-316) and the device port indicators 304a-316a independent of the port monitoring engine 303 (e.g., when the port monitoring engine 303 is not used for driving the device port indicators 304a-316a based on the operation of the device ports 304-316, but rather only used for transmitting port indicator data to the monitoring device as discussed below.) While a specific networking device 300 is illustrated and described herein, one of skill in the art in possession of the present disclosure will recognize that a wide variety of modification to the networking device 300 will fall within the scope of the present disclosure.

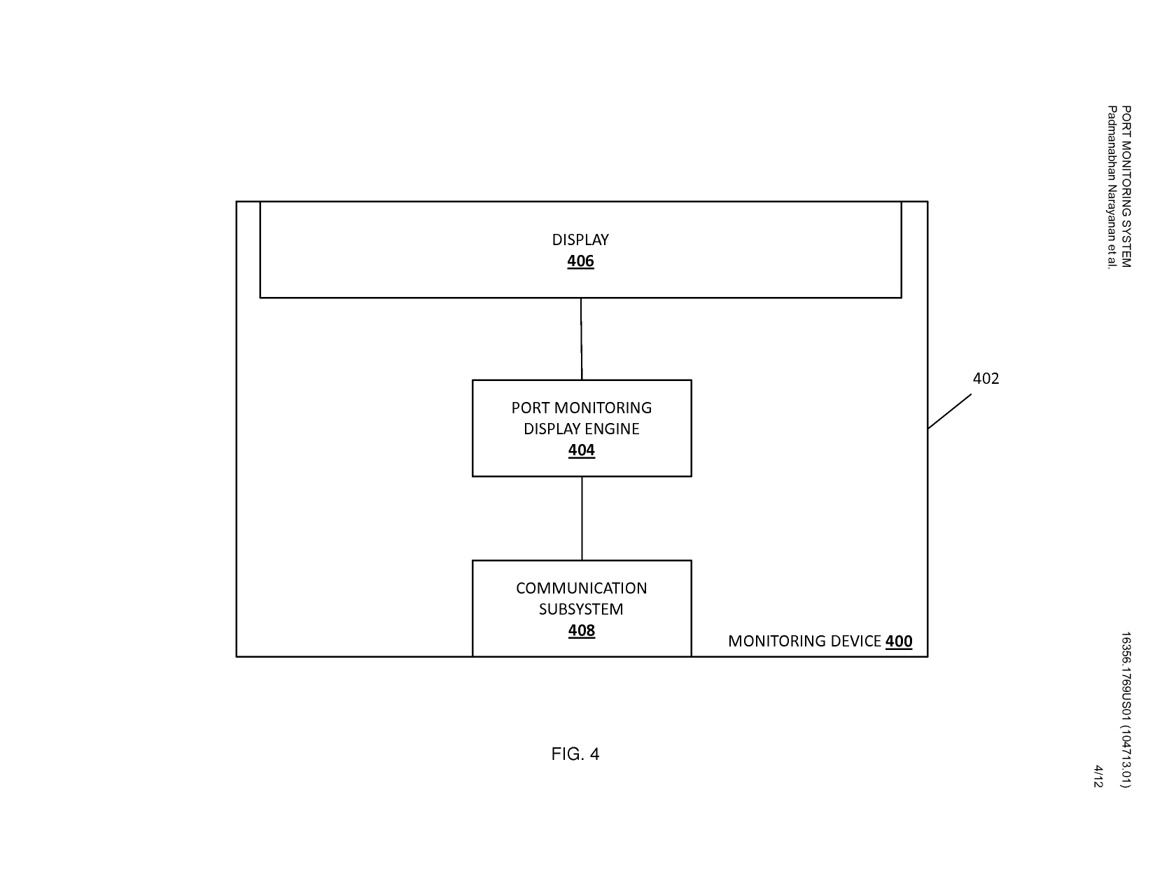

Referring now to FIG. 4, an embodiment of a monitoring device 400 is illustrated. In an embodiment, the monitoring device 400 may be the IHS 100 discussed above with reference to FIG. 1 and/or may include some or all of the components of the HIS 100. In an embodiment, the monitoring device 400 is the monitoring device 206 discussed above with reference to FIG. 2. For example, the monitoring device 400 may be a mobile phone, a tablet computer, a desktop computer, a laptop/notebook computer, and/or a variety of other computing devices known in the art. As such, the monitoring device 400 may include a variety of other computing components that are known in the art but not illustrated in FIG. 4 for clarity. In the illustrated embodiment, the monitoring device 400 includes a chassis 402 that houses the components of the monitoring device 400. For example, the monitoring device 400 includes a processing system that is housed in the chassis 402 (not illustrated, but which may be the processor 102 discussed above with reference to FIG. 1) and a memory system that is housed in the chassis 402 (not illustrated, but which may be the system memory 114 discussed above with reference to FIG. 1) and that includes instructions that, when executed by the processing system, cause the processing system to provide a port monitoring display engine 404 that is configured to perform the functions of the port monitoring display engines and monitoring devices discussed below. In a specific example, the port monitoring display engine 404 may include a graphical user interface application and/or a browser plugin applet that enables the viewing of the graphical user interfaces discussed below on the monitoring device 400.

The monitoring device 400 also includes a display 406 that may be housed in the chassis 402, accessible on an outer surface of the chassis 402, and/or otherwise provided in or on the chassis 402 in a variety of manners known in the art. The display 406 is coupled to the pot monitoring display engine 404 (e.g., via a coupling between the processing system and the display 406) and configured to display the screens discussed in further detail below. The monitoring device 400 also includes a communication subsystem 408 that is housed in the chassis 402 and coupled to the port monitoring display engine 404 (e.g., via a coupling between the processing system and the communication subsystem 408). In the embodiments discussed below, the communication subsystem 408 is discussed as including an integrated wireless communication subsystem (e.g., a Bluetooth communication subsystem, a Near Field Communication (NFC) subsystem, a WiFi communication subsystem, and/or a variety of other wireless communication subsystems known in the art) when, for example, the monitoring device is a mobile computer. However, in other embodiments, a wired communication subsystem (e.g., that is configured to connect to a communication cable such as an Ethernet cable or fiber optic cable) and/or a variety of other communication subsystems known in the art will fall within the scope of the present disclosure such as, for example, when the monitoring device 400 is a desktop computer.

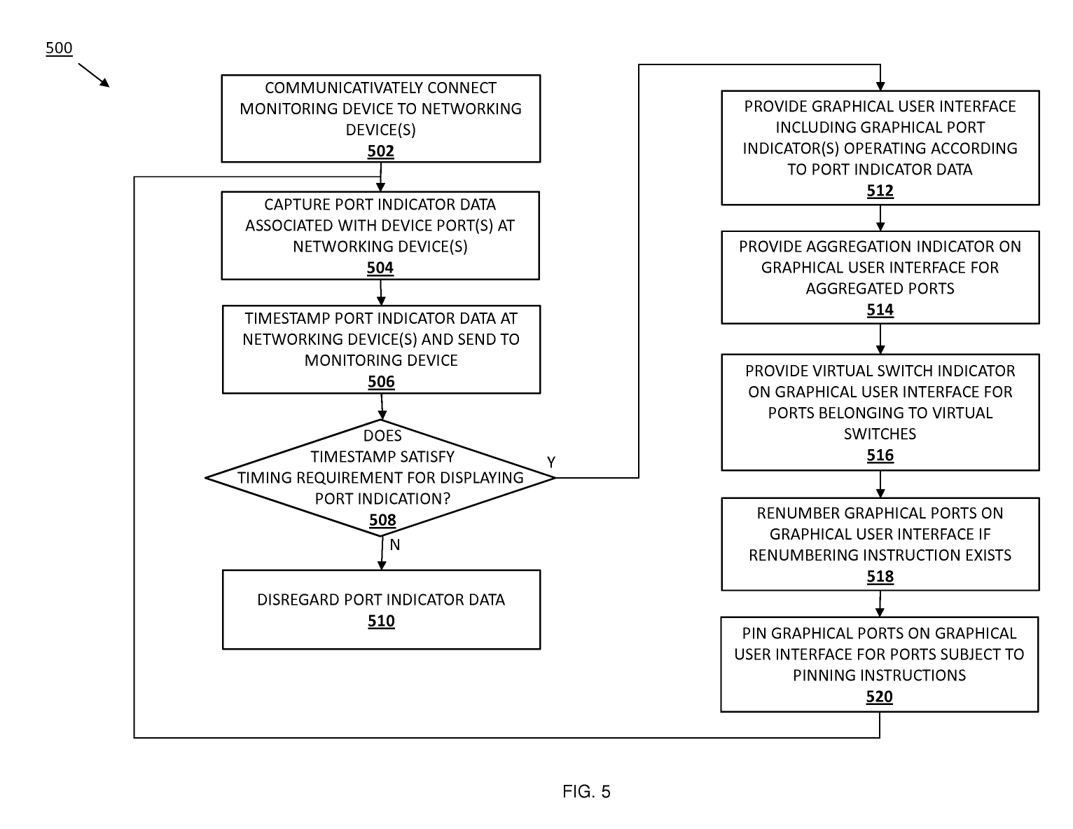

Referring now to FIG. 5, an embodiment of a method for monitoring ports is illustrated. As discussed below, embodiments of the method 500 and the port monitoring system 200 including the networking device 300 and monitoring device 400 discussed below may provide for the isochronous wireless transmission and graphical display of port indicator data on the monitoring device that allows a user to monitor the real-time status of device ports on networking devices, and provides a graphical user interface that greatly enhances the ability of a user to monitor a plurality of device ports and/or characteristics of those device ports and their networking devices. This is accomplished, at least in part, by time stamping port indicator data at the networking devices and wirelessly transmitting that port indicator data to the monitoring device, and then determining at the monitoring device whether the time stamp on received port indicator data satisfies timing requirements for providing a port indication, which ensures that graphical port indicators provided on the graphical user interface are displayed as operating accurately with respect to the device ports with which they are associated. In addition, the graphical user interface allows for any of a variety of user defined port number schemes to be provided using the graphical ports on the graphical user interface, as well as indications of properties associated with the device ports to be displayed on the graphical user interface such as, for example, port aggregations, virtual switch associations, and/or other port and device characteristics known in the art.

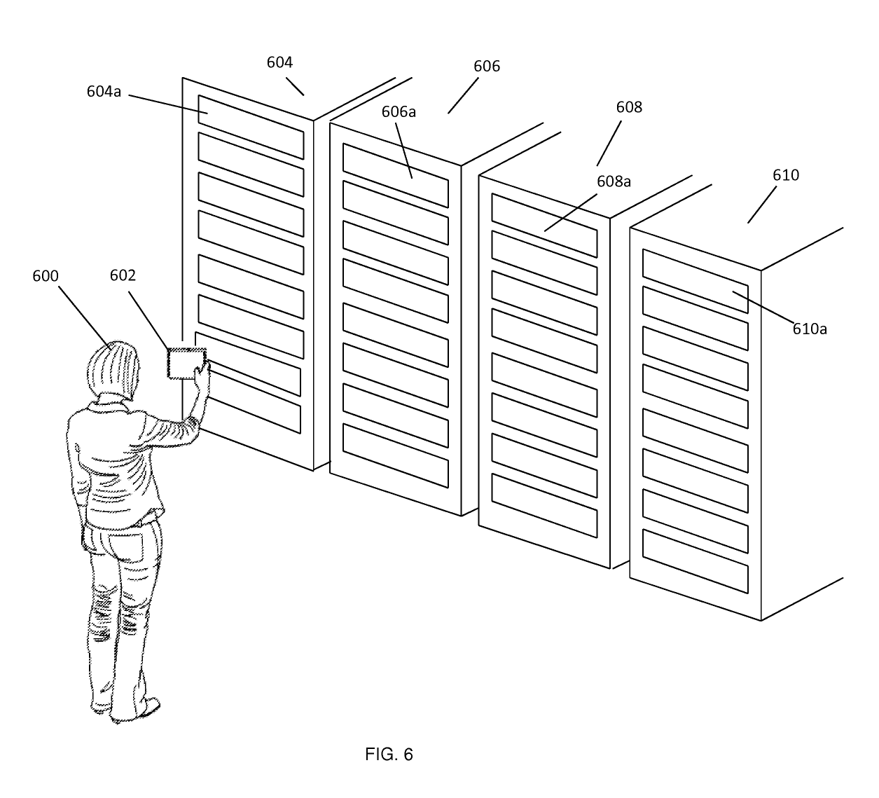

The method 500 begins at block 502 where a monitoring device is communicatively connected to one or more networking devices. Referring to FIG. 6, and with reference to FIGS. 3 and 4, a user 600 with a monitoring device 602 is located in a data center with a plurality of racks 604, 606, 608, and 610 that house a plurality of respective networking (and other) devices 604a, 606a, 608a, and 610a. In an embodiment, at block 502 the user 600 may communicatively couple the monitoring device 602 to the networking devices 604a-610a by launching an application (e.g., as included on the port monitoring display engine 404) that then utilizes the communication subsystem 408 in the monitoring device 602/400 to detect and connect to the networking devices 604-610 via communications provided to the port monitoring engine 303 in the networking devices 604-610/300 via their communications subsystems 306. In another embodiment, the monitoring device 602 and the networking devices 604-610 may be configured to automatically detect and connect to each other in response to being moved within a minimum distance of each other (e.g., the port monitoring display engine 404 and/or the port monitoring engine 303 may periodically sends discovery communications in an attempt to detect the other such that, when brought within the minimum communication distance of each other, a communicative connection is established.) Further details of the detection and connection of the monitoring device 602 and the networking device(s) 604a-610a are known in the art and will not be discussed in detail. While a specific embodiment is illustrated in FIG. 6, a wide variety of modification to that embodiment will fall within the scope of the present disclosure. For example, the user 600 may include monitoring device that, rather than being the wireless mobile device illustrated in FIG. 6, is provided by a desktop computer that includes wired connections to the networking devices 604a-610a and, at block 502, the user 600 may provide an instruction to the desktop computer monitoring device to detect and communicatively connect to any of those networking devices 604a-610a.

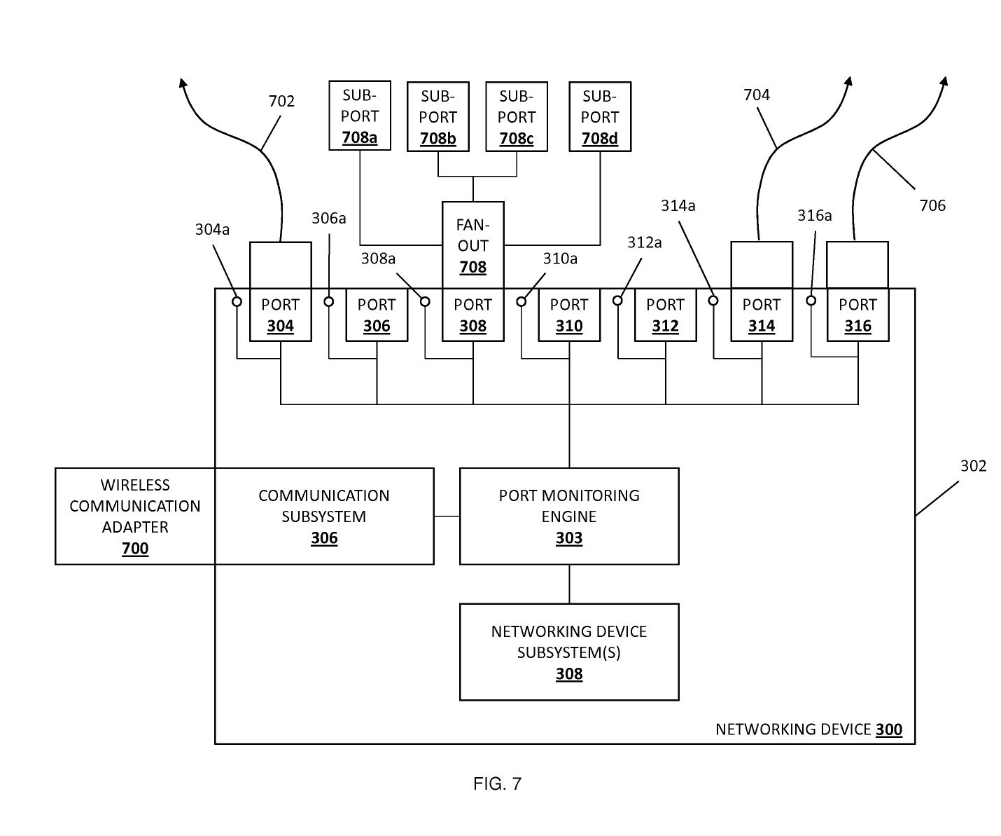

Referring to FIG. 7, an embodiment of the networking device 300 is illustrated that includes some systems, subsystems, and/or other features that may be utilized in any of the networking devices 604a-610a discussed above with reference to FIG. 6. In an embodiment, a wireless communication adapter 700 may be coupled to the communication subsystem 306 on the networking device 300 in order to provide for wireless communications utilized between the networking device 300 and the monitoring system 602 at block 502. For example, the wireless communication adapter 700 may be a wireless communication “dongle” that is configured to connect to a communication port provided by the communication subsystem 306 (e.g., directly, through a cable, etc.). In a specific embodiment, the wireless communication adapter 700 is a USB Bluetooth communication adapter that connects to a USB port on the communication subsystem 306 and that is configured to allow the communication subsystem 306 to receive Bluetooth communications. In an embodiment, the networking devices may be configured to detect the insertion of the wireless communication adapter 700 into the communication port, load a wireless communication adapter driver, and activate the port monitoring engine 303. Communication between the port monitoring engine 303 and the monitoring device 602 may then activate a console connection enabling access to the Command Line Interface (CLI) in the networking device, which the monitoring device 602 may then use to receive or retrieve the port indicator data as discussed below (e.g., by the port monitoring display engine 404 executing an “LED-panel line card 7” command on the CLI to stream the port indicator data for the line card in slot 7 of the networking device). However, the communication between the monitoring device 602 and the networking devices may be initiated to begin the transmittal of the port indicator data in a variety of other manners (e.g., via a GUI that provides for the selection of a line card and/or other port provisioning component of the networking device) that will fall within the scope of the present disclosure.

In other embodiments, the wireless communication adapter 700 may be an NFC adapter, a WiFi adapter, and/or any other wireless communication adapter known in the art. As such, in some embodiments, the user or a data center administrator may connect a wireless communication adapter to each networking device 300 in the data center that includes device ports that need to be monitored. Furthermore, in some embodiments, the port monitoring engine 303 may be provided in the wireless communication adapter 700 rather than the networking device 300. Such embodiments may allow for the connection of a wireless communication adapter 700 to a conventional networking device 300 in order to provide the port monitoring functionality discussed below (e.g., the port monitoring engine 303 in the wireless communication adapter 700 would be configured to retrieve the port indicator data discussed below from the networking device subsystem(s) 308 through the communication subsystem 306). In addition and as discussed above, in other embodiments the communication subsystem 306 may include a wireless communication system that is integrated into the networking device 300, or a wired communication subsystem while remaining within the scope of the present disclosure.

In an embodiment, networking cables (e.g., Ethernet cables, fiber optic cables, and/or other networking cables known in the art) may be connected to one or more of the device ports 304-316 on the networking device 300. For example, FIG. 7 illustrates a networking cable 702 connected to the device port 304, a networking cable 704 connected to the device port 314, and a networking cable 706 connected to the device port 316. Each of the networking cables 702, 704, and 706 may be connected to another device (e.g., a networking device, a computing device, a storage device, etc.) in the datacenter. As is known in the art, device ports on the networking device 300 that are connected to other devices in the data center may be configured in a variety of manners as desired by a user. For example, the device port 304 may be configured as part of a virtual switch that is provided by the networking device 300. In another example, the device ports 314 and 316 may be aggregated (e.g., in a Link Aggregation Group (LAG)) to allow them, for example, to be treated as a single, logical port when the networking cables 704 and 706 are connected to one or more devices. While a few examples of port configurations have been provided, one of skill in the art in possession of present disclosure will recognize that the device ports may be configured in a variety of manners known in the art while remaining within the scope of the present disclosure.

In an embodiment, a variety of types of cabling systems may be connected to one or more of the devices ports 304-316 on the networking device 300. For example, FIG. 7 illustrates a fan-out cabling system 708 that is connected to the device port 308 and that includes a plurality of device sub-ports 708a, 708b, 708c, and 708d. In an embodiment, the fan-out cabling system 708 provides a 1-to-4 “breakout” cable that allows the connection to the device port 308 to transmit data to any of the device sub-ports 708a-708d. In a specific example, the fan-out cabling system 708 may include a Quad Small Form-factor Pluggable (ESFP) fan-out cabling system and/or a variety of other fan-out or breakout cabling systems known in the art.

In an embodiment, the monitoring device 602 may display a graphical user interface to the user 600 in response to the monitoring device 602 connecting to the networking device(s) at block 502. For example, upon the connection of the monitoring device 602 and the networking device(s) 604a-610a, those networking device(s) may provide the monitoring device 602 (or the monitoring device 602 may retrieve from the networking device(s)) device information about the networking devices that provides for the display of the information discussed below. As such, that device information may include an identity of a rack that the networking device is located in, an identifier of the networking device, an identifier of each device port on the networking device, an identifier of each port indicator on the networking device, associations between device ports and port indicators; associations between device ports, associations of device ports with other subsystems (e.g., the virtual switches discussed below), details about connections to the ports (e.g., the network cables and/or the fan-out cabling system discussed above, and/or other devices known in the art), and/or any other device information known in the art that would allow for the functionality provided herein.

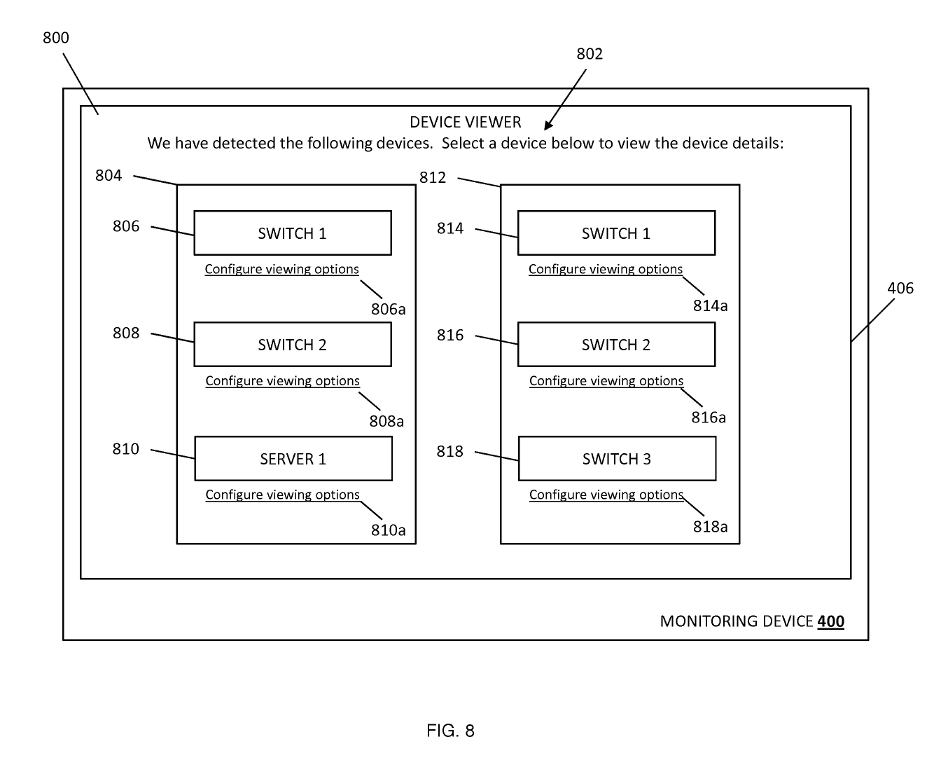

FIG. 8 illustrates an embodiment of the monitoring device 400 displaying a device detection and selection screen 800 on the display 406. In the illustrated example, the device detection and selection screen 800 includes user information 802 that informs the user 600 that devices have been detected and that the user may select a device to view details about that device. The device detection and selection screen 800 also provides a graphical user interface that includes a first graphical rack element 804 with a first graphical switch element 806 and an associated configuration options link 806a, a second graphical switch element 808 and an associated configuration options link 808a, and a first graphical server element 810 and an associated configuration options link 810a. Similarly, the graphical user interface on the device detection and selection screen 800 also includes a second graphical rack element 812 with a third graphical switch element 814 and an associated configuration options link 814a, a fourth graphical switch element 816 and an associated configuration options link 816a, and a fifth graphical server element 818 and an associated configuration options link 818a.

In an embodiment, the port monitoring display engine 404 may use information retrieved from the networking device(s) at block 502 such as, for example, an identifier for the networking device and an identifier for a rack they are located in, to provide the graphical elements illustrated in the device detection and selection screen 800. As such, two networking devices may provide their identifiers (i.e., “SWITCH 1” and “SWITCH 2”) as well as identifiers for the rack they are located in to the monitoring device 400, and the port monitoring display engine 404 may use those to provide the first graphical rack element 804 with the first and second graphical switch elements 806 and 808. In addition, the device detection and selection screen 800 also illustrates how the monitoring device 400 may communicate with non-networking devices (e.g., the “SERVER 1”) to receive and display details about those types of devices as well. The second graphical rack element 812 and graphical switch elements 814-818 may be provided in substantially the same manner.

In an embodiment, the user 600 may select any of the configuration options links 806a-810a and 814a-818a associated with the graphical elements 806-810 and 814-818 in order to configure how the details of those devices may be viewed as discussed below. While not illustrated or discussed in detail, selection of the configuration options for any graphical element may allow a user to adjust how graphical elements are displayed on the monitoring device. For example, the user may configure whether storage devices are displayed (i.e., the monitoring device 400 may be communicating with a storage device, but no graphical element is provided on the device detection and selection screen 800 because the user have configured the system to not display storage devices.) In addition, colors, sizes, placements, and/or other details may be defined by the user 600 as desired. While configuration options are illustrated as provided for each of the device graphical elements, configuration options may also be provided per rack graphical element to defined, for example, how the rack graphical elements are displayed, how device graphical elements are displayed within a rack graphical element, etc.

The method 500 then proceeds to block 504 where port indicator data associated with one or more device ports is captured at one or more of the networking devices. As the networking device 300 operates, the device ports 304-316 connected to other devices send and receive data and/or perform other operations known in the art. Conventionally, such operation of the device ports 304-316 is detected by the networking device subsystem(s) 308 (e.g., the PHYs and/or LED processors discussed above) and used to activate their associated device port indicators 304a-316a to provide an indication of the operation of the device ports 304-316. For example, activation of the LED device port indicators is typically used to indicate a link state of their associated device port and an activity of their associated device port. As such, two LED device port indicators may be provided for each device port on a switch to allow for the indication of the operation of that device port, and those LED device port indicators typically provide such indications by emitting a particular color and/or blinking on and off.

In an embodiment, at block 504 the port monitoring engine 303 may retrieve the port indicator data that is associated with the operation of any or all of the device ports 304-316. For example, the port monitoring engine 303 may receive that port indicator data from the networking device subsystem(s) 308, generate that port indicator data in response to the detected operation of the device ports 304-316, retrieve that port indicator data as it is generated by the networking device subsystem(s) 308, and/or utilizing any of method that would be apparent to one of skill in the art for capturing port indicator data that is associated with the operation of the device ports 304-316. In a specific example, and with reference to FIG. 7, the port indicator data may be indicative of the operation of device port 304 as is sends and receives data, or otherwise operates, while connected to the networking cable 702. In another specific example, and with reference to FIG. 7, the port indicator data may be indicative of the operation of device ports 314 and 316 as they send and receive data, or otherwise operate, as part of a LAG while connected to the networking cables 704 and 706, respectively. In another specific example, and with reference to FIG. 7, the port indicator data may be indicative of the operation of device port 308 as it sends and receives data, or otherwise operates, while connected to the fan-out cabling system 708. In such an example, the port monitoring engine 303 may be configured to distinguish the port indicator data associated with device port 308 as sub-port indicator data associated with each of the device sub-ports 708a-708d on the fan-out cabling system 708. As such, respective device sub-port indicator data may be indicative of the operation of each of the device sub-ports 708a-708d as those device sub-ports send and receive data, or otherwise operate. While several examples have been provided, one of skill in the art in possession of the present disclosure will recognize that any of a variety of port indicator data may be retrieved at block 504 while remaining within the scope of the present disclosure.

The method 500 then proceeds to block 506 where the networking device(s) timestamp the port indicator data and send it to the monitoring device. In an embodiment, the port monitoring engine 303 operates to timestamp the port indicator data captured at block 504 with a current time, and then uses the communication subsystem 306 to send that time stamped port indicator data to the monitoring device 602. For example, referring to FIG. 7, the port monitoring engine 303 may utilize the wireless communication adapter 306 to wirelessly transmit the time stamped port indicator data to the monitoring device 602/400 such that the time stamped port indicator data is received by the port monitoring display engine 404 through the communication subsystem 408. However, in other examples, the port monitoring engine 303 may utilize an integrated wireless communication subsystem 306 or a wired connection to the communication subsystem 306 to transmit the time stamped port indicator data to the monitoring device 602. In an embodiment, the port monitoring engine 303 may send the time stamped port indicator data along with information about the device port, the device, the rack, and/or other information that would allow for functionality discussed below. For example, port indicator data may include physical-to-software defined port numbering, networking operating systems associated with the port, port type (e.g., if the port is connected to a fan-out cabling system), transceiver type, aggregation information, and/or a variety of other port indicator data information known in the art.

In a specific embodiment, the port monitoring engine 303 may receive a stream of port indicator data (which is conventionally provided to the LED processors to drive physical LEDs) that is typically a few bytes per device port indicator, at approximately 30 frames per second. The port monitoring engine 303 may then time stamp that port indicator data, and forward that stream of time stamped port indicator data to the monitoring device. For example, the port monitoring engine 303 may capture the port indicator data over an internal backplane from line cards in the networking device, encapsulate each port indicator data frame into a packet, timestamp those packets, and transmit those timestamp packets at the requested frame rate (e.g., 30 frames per second). In some embodiments, the port monitoring engine and the monitoring device may be clients of a time service (e.g., the Network Time Protocol (NTP) and thus have a common time source with at least microsecond accuracy.

The method 500 then proceeds to decision block 508 where the monitoring device determines whether the time stamp on the time stamped port indicator data satisfies a timing requirement for displaying a port indication. In an embodiment, the port monitoring display engine 404 may include one or more timing requirements for displaying a port indicator (e.g., programmed in the port monitoring display engine 404, included in a database coupled to the port monitoring display engine 404, etc.). As such, timing requirements for displaying a port indication may different depending on the type of port indicator data, the port, the device the port is located on, and/or any other criteria desired by a user for displaying a port indication.

In some embodiments, the timing requirement for displaying a port indication may be based upon the rate at which port indicator data is generated, retrieved, received, captured, or otherwise provided by the networking device(s). For example, the networking device(s) may be configured to generate port indicator data at thirty frames per second, and the timing requirement may be based on that port indicator data generation rate (i.e., port indicator data with a timestamp that indicates that the port indicator data is more than 2/30^{th} of a second old may not satisfy the timing requirement. In a specific example, assuming that the user chooses to have port indicator data generated at 30 frames per second, a frame will be provided by the networking device every 33.33 msecs. If the networking device generates n sequential frames with timestamps T1, T2 and up to Tn, the monitoring device will receive those frames at T1′, T2′ and up to Tn′, where T1′=T1+delay1, T2′=T2+delay2, and Tn′=Tn+delay-n, with delay1, delay2, and up to delay-n are delays caused due to the transmitter/receiver stack and the packet in transit. If the user selects to have 90% accuracy, the monitoring device may ensure that packets exceeding a delay of >3.33 msecs are dropped (i.e., the maximum permissible delay will be only 10% of the frame slot time) and that packet ordering is preserved. While specific examples have been provided, one of skill in the art in possession of the present disclosure will recognize that the timing requirement for displaying a port indication may be determined in a variety of manners that may ensure that port indicator data is recent enough to provide an accurate indication of the operation of its associated device port, and timing requirements according to those techniques are envisioned as falling within the scope of the present disclosure.

If, at decision block 508, the monitoring device 602 determines that the timestamp on the time stamped port indicator data received at block 506 does not satisfy the timing requirement for displaying a port indication, the method 500 proceeds to block 510 where the port indicator data is disregarded. As discussed below, in some embodiments, the display of port indications using port indicator data is intended to be real-time and isochronous with respect to the operation of respective ports on the networking device(s) and, as such, any port indicator data that includes a timestamp that does not satisfy the timing requirements for displaying a port indication may be disregarded by the port monitoring display engine 404 such that it is not used in displaying a port indication as discussed below. In specific example, time stamped packets that includes encapsulated port indicator data may be dropped if the time stamp provided on the packet does not satisfy the timing requirement.

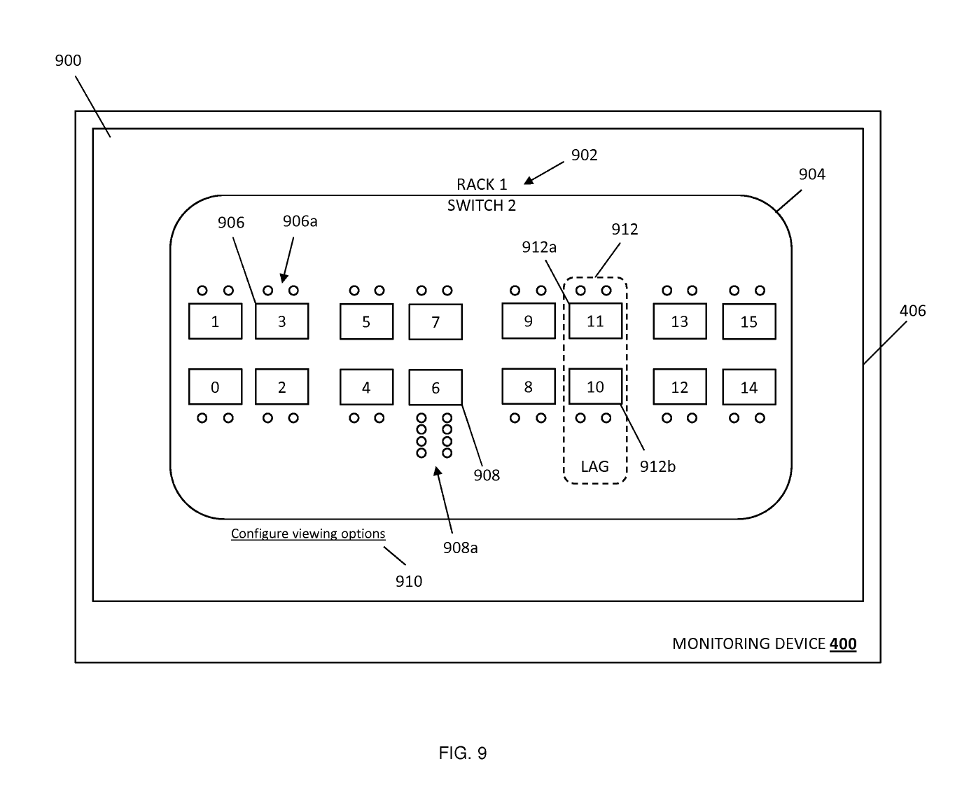

If, at decision block 508, the monitoring device 602 determines that the time stamp on the time stamped port indicator data received at block 506 satisfies the timing requirement for displaying a port indication, the method 500 proceeds to blocks 512, 514, 516, 518, and/or 520 where graphical user interfaces are provided that includes one or more graphical port indicators operating according to the port indicator data. For example, if the timestamp on a port indicator data packet satisfies the timing requirement, the port monitoring display engine 404 may extract the port indicator data from the packet, repackage the port indicator data as required by the configurations of the graphical user interfaces discussed below, and use the port indicator data to the display the graphical port indicators as discussed below. FIG. 9 illustrates an embodiment of the monitoring device 400 displaying a device monitoring screen 900 on the display 406 that may be provided in response to the user 600 selecting the second graphical switch element 808 on the device detection and selection screen 800 illustrated in FIG. 8. For example, the port monitoring display engine 404 may snoop commands provided on the monitoring device 400 and launch the device monitoring screens discussed below based on selected devices. However, in other examples, snooping may not be necessary when the port monitoring display engine displays a GUI to provide for the selection of devices to request relevant port data from the networking devices. In the illustrated example, the device monitoring screen 900 includes device information 902 that informs the user 600 of details of the device that was selected and about which information is being displayed (e.g., “SWITCH 2” in “RACK 1”). The device monitoring screen 900 also provides a graphical user interface that includes a graphical switch element 904 including a plurality of graphical ports and associated graphical port indicators. For example, a graphical port element 906 (e.g., for port “3” in the illustrated embodiment) is associated with graphical port indicators 906a, and other graphical elements are associated with respective graphical port indicators as can be seen.

In an embodiment, the port monitoring display engine 404 may use information retrieved from the networking device(s) at block 502 such as, for example, an identifier for the networking device, an identifier for a rack the networking device is located in, identifiers for the device ports on the networking device, identifiers for the device port indicators, information about cables and/or other systems connected to the device ports, association between device ports, associations between device ports and device port indicators, association between device ports and networking device subsystems, and/or any other information known in the art to provide the graphical elements illustrated in the device monitoring screens discussed below. As such, a networking device may provide its identifiers (i.e., “SWITCH 2”) as well an identifier for the rack it is located in, identifiers for its ports, identifiers and/or associations between its device port indicators and its device ports, associations between devices ports, and/or other information to the monitoring device 400, and the port monitoring display engine 404 may use those to provide the graphical display of “SWITCH 2” in FIG. 9.

At block 512, the port monitoring display engine 404 may use the port indicator data that includes the timestamp that satisfies the timing requirement for displaying a port indication to provide the graphical port indicators on the device monitoring screen 900 operating according to the port indicator data and thus according to the operation of the device port that resulted in the creation of that port indicator data. In an embodiment, the port monitoring display engine 404 may use the port indicator data to display the graphical port indicators 906a operating as per the device port on the networking device that is associated with that port indicator data. For example, the graphical port indicators 906a may be displayed to indicate a link state (e.g., red for “down”, yellow for “limited”, green for “up”), to indicate a link activity (e.g., “blinked” to indicate data transmission or a rate of data transmission), to indicate a link speed, to indicate a link duplexity, to indicate link collisions, to indicate transmission or reception of data, to indicate flow control, to indicate PHY status, to indicate any other device port status that can be derived by software based on the MAC layer counters or error information, and/or to indicate any other device port operation or characteristic known in the art. In an embodiment, the user 600 may define which of those device port operations they would like to view on the device monitoring screen 900. In addition, the user 600 may define the time scale, buffer capture capabilities, line cards within the networking devices, the rate of port indicator data update (e.g., 30 frames per second), and/or any other features of the graphical port indicator operation. Updates to graphical port indicator display configurations may be provided to the port monitoring engine 303 in the networking device during initialization, when a networking operating system is instantiated, when port properties change (e.g., when link aggregation changes, a fan-out cabling system is connected to a port, a port is activated or deactivated, etc.), and/or in response to a variety of other configuration update scenarios known in the art.

As such, the graphical port indicators 906a for the graphical port 906 may operate in the same manner as do the device port indicators for the corresponding device port on the networking device that provided the port indicator data. However, as discussed below one of skill in the art in possession of the present disclosure will appreciate that, in some embodiments, the teachings of the present disclosure may be utilized to eliminate physical device port indicators on networking devices (i.e., to display that graphical port indicators on the monitoring device that correspond to the operation of device ports that do not have associated display port indicators on the networking devices).

FIGS. 7 and 9 provide an example of the provision of the graphical port indicators when no device port indicators exist on the networking device. For example, as discussed above, the fan-out cabling system 708 provides the device sub-ports 708a-708d that may operate substantially as the device ports 304-316, with the exception that all data transmitted through the device sub-ports 708a-708d flows through the device port 308. In many embodiments, the device sub-ports 708a-708d are not associated with any device sub-port indicator (i.e., any physical LEDs that indicate the operation of the device sub-ports 708a-708d). The port monitoring engine 303 may be configured to distinguish the operation of each of the device sub-ports 708a-708d (e.g., via communication with the fan-out cabling system 708 and/or the device sub-ports 708a-708d) to provide one or more graphical device sub-ports for display on the monitoring device 602. For example, the operation of each of the device sub-ports 708a-708d may generate respective sub-port indicator data that is captured by the port monitoring engine 303, time stamped, and provided to the monitoring device 602 as discussed above.

FIG. 9 illustrates an embodiment of the port monitoring display engine 404 providing a graphical port 908 (e.g., corresponding to the device port 308 on the networking device 300) with graphical sub-port indicators 908a. At block 512, the port monitoring display engine 404 may use the sub-port indicator data that includes the timestamp that satisfies the timing requirement for displaying a port indication, discussed above, to provide the graphical sub-port indicators 908a on the device monitoring screen 900 operating according to the sub-port indicator data and thus according to the operation of the device sub-ports that resulted in the creation of that port indicator data. In an embodiment, the port monitoring display engine 404 may use the sub-port indicator data to display the graphical sub-port indicators 908a operating as per the respective device sub-ports 708a-708d on the fan-out cabling system 708 that are associated with that port indicator data. For example, the graphical sub-port indicators 908a may be displayed to indicate a link state (e.g., red for “down”, yellow for “limited”, green for “up”), to indicate a link activity (e.g., “blinked” to indicate data transmission or a rate of data transmission), to indicate a link speed, to indicate a link duplexity, to indicate link collisions, to indicate transmission or reception of data, to indicate flow control, to indicate PHY status, and/or to indicate any other device sub-port operation known in the art. As such, the graphical sub-port indicators 908a for the fan-out cabling system 708 may displayed according to the operation of the corresponding device sub-ports 708a-708d on the fan-out-cabling system 708 that provided the port indicator data. As such, as can be seen in the illustrated embodiment, coupling a 1-to-4 fan-out cabling system to the device port 308 may result in the display of 4 pairs of graphical device sub-port indicators 908a (one pair for each device sub-port 708a-708d) along with the graphical port 908 (e.g., port “6”) that corresponds to the device port 308.

The use of graphical port indicators provides the user with the ability to configure the display of the operation of device ports on the networking devices in a variety of manners. As illustrated in FIG. 9, a configurations options link 910 is displayed on the device monitoring screen 900, and the user 600 may select the configuration options links 910 in order to configure how the details of the device may be viewed similarly as discussed for the configuration options links 806a-810a and 814a-818a on the device detection and selection screen 800. While not illustrated or discussed in detail, selection of the configuration options for any graphical element may allow a user to adjust how graphical elements are displayed on the monitoring device. In an embodiment, the user 600 may select any of the configuration options links 910, 806a-810a, and 814a-818a associated with the device being monitored on the device monitoring screen 900 to define how the graphical port indicators (or graphical sub-port indicators) are displayed for any device port (or device sub-port). For example, the user 600 may define the colors associated with any operating condition of a device port (as indicated by the port indicator data) for any graphical port indicator. As such, port indicator data that is configured to cause a device port indicator on the networking device to provide a first color (e.g., green) may be defined by the user to provide a graphical port indicator that provides a second color (e.g. purple) that is different than the first color. This enables, for example, the use of different colors (relative to the graphical and physical port indicators) to display the same operation, the use of different colors (on the graphical port indicator) to display different operations, etc. Similarly, the user 600 may define the “blink” rate associated with any operating condition of a device port (as indicated by the port indicator data) for any graphical port indicator. As such, port indicator data that is configured to cause a device port indicator on the networking device to blink at a first rate may be defined by the user to provide a graphical port indicator that blinks at a second rate that is different than the first rate.

One of skill in the art in possession of the present disclosure will recognize that such functionality allows the user to define one or more graphical port indicators for the graphical ports on the device monitoring screens that display port indicator data in non-conventional manners in order to allow for the quick distinguishing between ports of interest, and provides for any of a variety of port indicator operation definitions and modifications that simply are not available using physical port indicators. For example, the operation of the graphical port indicators may be dynamically changed based on a time of day, on the type of device the device port is connected to, etc. While examples of color and blink rate have been described, any port indicator operation may be defined and/or modified while remaining within the scope of the present disclosure. Furthermore, the display of the graphical port indicators may be changed depending on the stage of the networking device. For example, the graphical port indicators may be defined to operate according to first characteristics during manufacture and testing, second characteristics once deployed, third characteristics when debugging, etc.

In addition to providing the graphical port indicators that display the real-time, isochronous operation of the device ports on the networking devices, the port monitoring display engine 404 may provide graphical user interfaces that provides a variety of information that simply is not possible to provide on physical networking devices, physical device ports, and using physical device port indicators. For example, at block 514 of the method 500, aggregation indicator(s) may be provided on the graphical user interface for aggregated ports. As discussed above, device ports on the networking device may be aggregated (e.g., into a LAG), and at block 514, the port monitoring engine 404 may determine those aggregations using device information and/or port indicator data and, in response, display an aggregation indicator. FIG. 9 illustrates an embodiment of the device monitoring screen 900 displaying an aggregation indicator 912 along with graphical ports 912a and 912b (e.g., ports “10” and “11”) that are aggregated. For example, two (or more) of the device ports on a networking device (or more than one networking device) may be part of a LAG, and in response, the graphical ports (e.g., graphical ports 912a and 912b) corresponding to those device ports may be displayed within the aggregation indicator 912 to quickly indicate to the user 600 that those ports are aggregated.

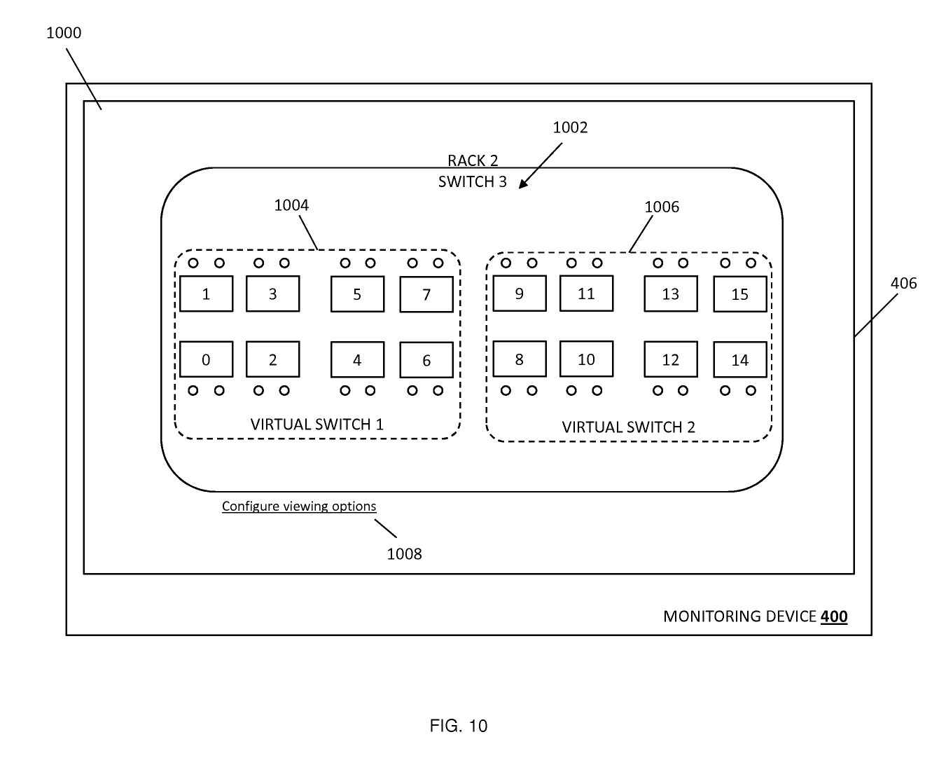

In another example of the graphical user interfaces providing a variety of information that simply is not possible to provide on physical networking devices, physical device ports, and using physical device port indicators, at block 516 of the method 500, virtual switch indicator(s) may be provided on the graphical user interface for ports belonging to a virtual switch. As discussed above, networking devices may be used to provide one or more virtual networking device such as virtual switches, and at block 514, the port monitoring engine 404 may detect those virtual switches using device information and/or port indicator data and, in response, display one or more virtual switch indicators. FIG. 10 illustrates an embodiment of the device monitoring screen 1000 that may be displayed, for example, in response to the user 600 selecting the graphical switch element 818 on the device detection and selection screen 800. The device monitoring screen 1000 includes device information 1002 that informs the user 600 of details of the device that was selected and about which information is being displayed (e.g., “SWITCH 3” in “RACK 2”), as well as graphical ports and graphical port indicators that are substantially similar to those discussed above with reference to the device monitoring screen 900. However, the device monitoring screen 1000 also displays a virtual switch indicator 1004 that indicates a plurality of graphical ports (e.g., ports “0-7”) and their associated graphical port indicators are part of a virtual switch (e.g., “VIRTUAL SWITCH 1”), and a virtual switch indicator 1006 that indicates a plurality of graphical ports (e.g., ports “8-15”) and their associated graphical port indicators are part of a different virtual switch (e.g., “VIRTUAL SWITCH 2”). For example, different device ports on a networking device (or more than one networking device) may be used in different virtual switches provided by the networking devices, and in response, the graphical ports corresponding to those device ports may be displayed within the virtual switch indicator 1004 and 1006 to quickly indicate to the user 600 which device ports/graphical ports are part of which virtual switches. As can be seen, the device monitoring screen 1000 also includes a configuration options link 1008 that is similar to the configuration options links discussed above, and that allows the user 600 to define the display of the graphical ports and graphical port indicators (e.g., as displayed for each virtual switch) similarly as discussed above.

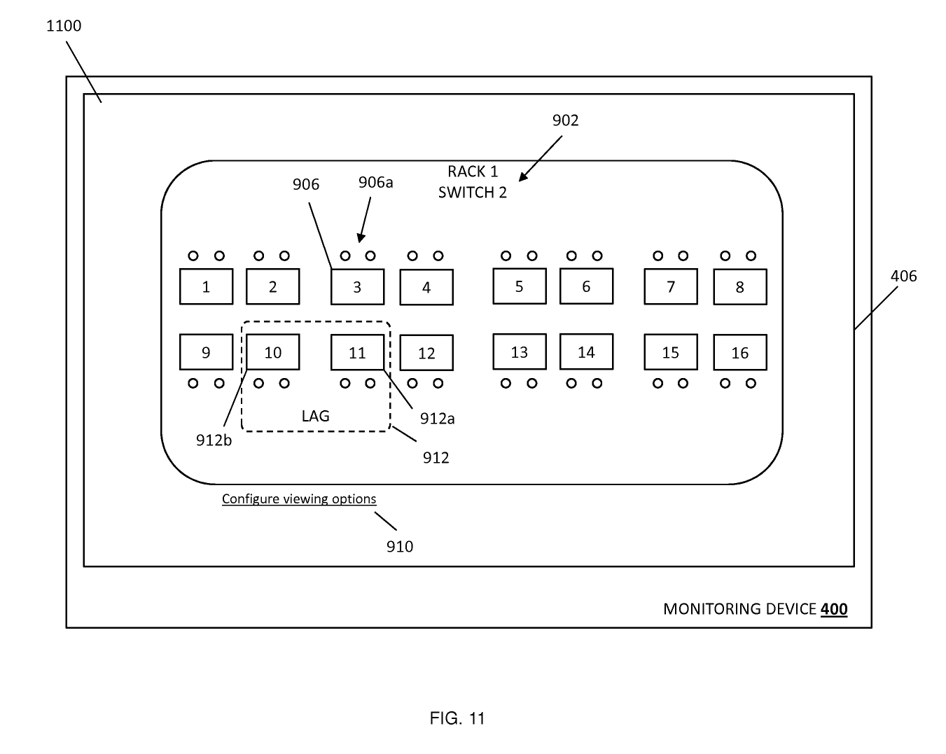

The port monitoring display engine 404 may also provide the graphical user interfaces that provide the ability to modify information associated with the networking devices in a manner that simply is not possible on physical networking devices, physical device ports, and using physical device port indicators. For example, at block 518 of the method 500, the graphical ports on the graphical user interface may be renumbered based on renumbering instructions. With reference to FIGS. 9 and 11, a networking device may provide numbering for device ports (e.g., printed on a silk screen on a surface of the networking device that includes the device ports) that sets the numbering of the device ports physically on an outer surface of the networking device. However, users may wish to renumber the ports, provide a different numbering scheme, or otherwise modify the set numbering convention provided on the networking device, and may use the configuration options links discussed herein to provide renumbering instructions for any networking device or device ports in the system. For example, the device monitoring screen 900 of FIG. 9 illustrates a numbering of the graphical ports that may correspond to the numbering of the device ports on the associated networking device (e.g., SWITCH 2 in RACK 1). However, the user 600 may use the configuration options link (e.g., the configuration options link 910) to provide renumbering instructions that modify the number of the graphical ports with respect to the numbering provided for the device ports on the networking device. Such renumbering may be beneficial, for example, when a user runs a networking operating system on a networking device that uses a different port numbering scheme than was provided on the networking device by a networking device manufacturer or vendor. As discussed below, this may provide for port numbering starting at “1” rather than “0”, port numbering starting from the top left of the device ports rather than the bottom left of the device ports, port numbering restarting for each virtual switch provided by a networking device, and/or other modifications known in the art.

For example, the device monitoring screen 1100 of FIG. 11 illustrates a re-numbering of the graphical ports relative to the number of the graphical ports provided on the device monitoring screen 900 (and corresponding to the physical numbering of the device ports on the networking device as discussed above). As can be seen, graphical port 906 (e.g., port “3”) and graphical port indicators 906a are displayed in a different position on the device monitoring screen 1100 relative to the device monitoring screen 900. Similarly, the aggregation indicator 912, along with the graphical ports 912a and 912b that are indicated as aggregated, are displayed in a different position on the device monitoring screen 1100 relative to the device monitoring screen 900. Thus, the user 600 may provide modifications to the physical numbering of the device ports such that custom port numbering is displayed when the graphical ports are provided on the monitoring device. While a specific renumbering scenario has been illustrated and described, one of skill in the art in possession of the present disclosure will recognize that any of a variety of renumbering schemes may be applied (e.g., including time-based renumbering schemes based on the time of day or year, device based renumbering schemes based on the devices connected to the device ports, etc.) while remaining within the scope of the present disclosure.

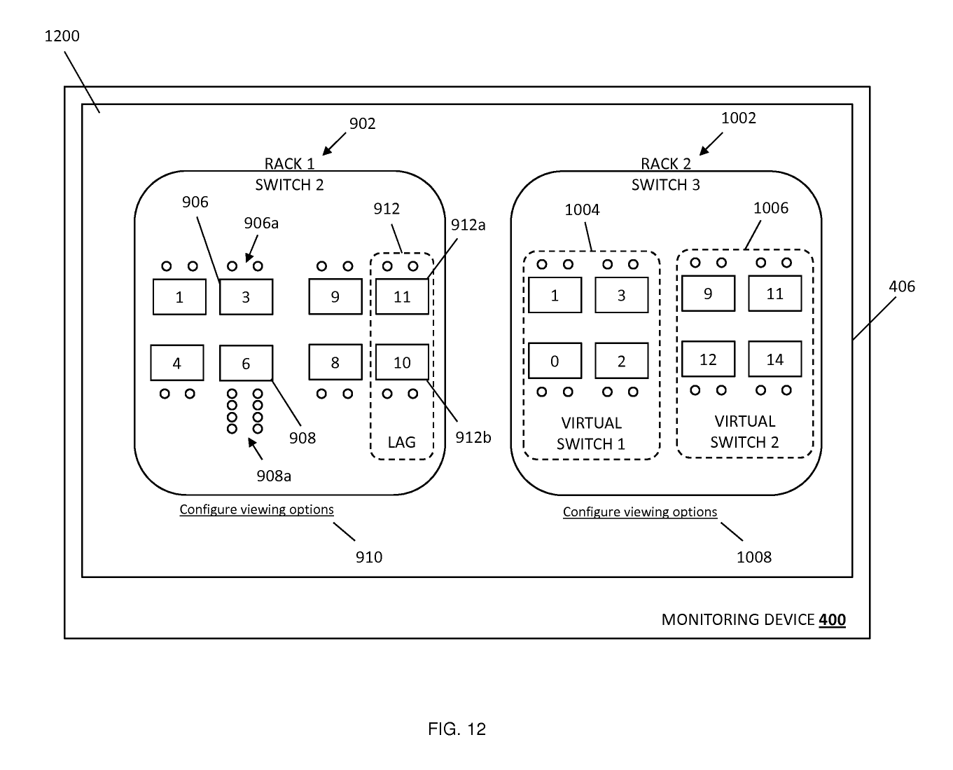

In another example of the graphical user interfaces enabling the display of a variety of information that simply is not possible with physical networking devices, physical device ports, and using physical device port indicators, at block 520 of the method 500, graphical ports on the graphical user interface may be “pinned” according to pinning instructions. Referring now to FIG. 12, a device monitoring screen 1200 is illustrated that provides a graphical user interface with graphical switch elements, graphical ports, and graphical port indicators that have been “pinned” or otherwise selected by the user 600 for continued viewing on the monitoring device 400. In an embodiment, using any of the device monitoring screens discussed above, a user may select a graphical switch element for continued viewing by providing a pinning instruction associated with the graphical switch element. For example, the user may have selected the graphical switch elements for SWITCH 2 in RACK 1 and SWITCH 3 in RACK 2 in order to have those graphical switch elements provided on the device monitoring screen 1200. In an embodiment, using any of the device monitoring screens discussed above, a user may select a graphical port for continued viewing by providing a pinning instruction associated with the graphical port. For example, the user may have selected the graphical ports for PORTS 1, 3, 4, 6, 8, 9, 10, and 11 in SWITCH 2 of RACK 1, as well as the graphical ports for PORTS 0, 1, 2, 3, 9, 11, 12, and 14 in SWITCH 3 of RACK 2, in order to have those graphical ports, as well as their associated graphical port indicators, provided on the device monitoring screen 1200. As can be seen, graphical port indicators (e.g., 906a and 908a), aggregation indicators (e.g., 912), and virtual switch indicators (e.g., 1004 and 1006) may be provided on the device monitoring screen 1200 when pinning instructions are executed. As such, the user 600 may select devices and ports of interest for continued viewing, and may then view the operation of those ports via the real-time, isochronous display of that operation using the graphical port indicators as discussed above.

In other embodiments, the graphical user interfaces discussed above may be configured to allow the user 600 to stop, pause, and/or save the streamed port indicator data, which allows for the comparison of device port behavior with, for example, systems logs from the networking device console output. Such saved port indicator data may be saved in a variety of compression formats that preserve the timestamp provided during the method 500, and may be provided to the monitoring device or other computing systems to “replay” the operation of the device ports and correlate that operation with the system logs.

Thus, systems and methods have been described that for the real-time, isochronous streaming of port indicator data about the operation of device ports to a monitoring device, which allows that monitoring device to display graphical port indicators that are displayed according to the operation of those device ports. Such functionality is enabled, at least in part, by time stamping port indicator data and then utilizing that port indicator data to provide the graphical port indicator when the time stamp on that port indicator data satisfies a timing requirement for displaying a port indication. In addition, the graphical display of the device port indicators and device ports provides the ability to renumber device ports, select custom colors and port indicator operations, indicate port aggregations, indicate virtual switches, and “pin” ports for continued viewing while being able to monitoring the operation of those ports through the real-time, isochronous display of the port indicator data using the graphical port indicators. As such, the systems and methods provide the ability to quickly and easily monitor remote or hard to view ports on one or more networking devices from a monitoring device, while allowing the user to customize that monitoring to greatly enhance the monitoring of devices and their ports relative to conventional systems and methods.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A port monitoring system, comprising:
a networking device that includes a device port, wherein the networking device is configured to capture port indicator data that is associated with the operation of the device port, timestamp the port indicator data, and wirelessly transmit the port indicator data; and
a monitoring device that includes a display, wherein the monitoring device is configured to wirelessly receive the port indicator data from the networking device, determine that the timestamp on the port indicator data satisfies a timing requirement for displaying a port indication and, in response, provide a graphical user interface on the display that includes a graphical port indicator that operates according to the port indicator data.

2. The port monitoring system of claim 1, wherein the networking device includes a communications port, and wherein a wireless communication adapter that has been coupled to the communications port provides for the wireless transmission of the port indicator data.

3. The port monitoring system of claim 1, wherein the graphical user interface includes a graphical port that corresponds to the device port.

4. The port monitoring system of claim 3, wherein the device port is associated with a device port number, and wherein the graphical user interface includes the graphical port with a graphical port number that is different than the device port number.

5. The port monitoring system of claim 3, wherein the device port is aggregated with at least one other device port on the networking device; and
wherein the monitoring device is configured to provide the graphical user interface with an indication that the graphical port is aggregated with at least one other graphical port.

6. The port monitoring system of claim 1, wherein the device port is connected to a fan-out system that provides a plurality of device sub-ports that are coupled to the device port, the port indicator data includes respective sub-port indicator data that is associated with the operation of each of the plurality of device sub-ports, and the graphical user interface includes respective graphical sub-port indicators that correspond to each of the plurality of device sub-ports and that operate according to the respective sub-port indicator data.

7. The port monitoring system of claim 1, further comprising:
at least one device port indicator that is included on the networking device and that is associated with the device port, wherein the networking device is configured to use first port indicator data associated with a first operation of the device port to provide the at least one port indicator with a first color; and
wherein monitoring device is configured to use the first port indicator data associated with the first operation of the device port to provide the graphical user interface including the graphical port indicator with a second color that is different than the first color.

8. An information handling system (IHS), comprising:
a display device;
a wireless communication subsystem;
a processing system that is coupled to the display device and the wireless communication device; and
a memory system that is coupled to the processing system and that includes instructions that, when executed by processing system, cause the processing system to provide a port monitoring engine that is configured to:
receive, from a networking device using the wireless communication subsystem, port indicator data that is associated with the operation of a device port on the networking device;
determine that a timestamp on the port indicator data satisfies a timing requirement for displaying a port indication; and
provide, on the display device in response to the timestamp on the port indicator data satisfying the timing requirement, a graphical user interface that includes a graphical port indicator that operates according to the port indicator data.

9. The IHS of claim 8, wherein the graphical user interface includes a graphical port that corresponds to the device port.

10. The IHS of claim 9, wherein the device port on the networking device is associated with a device port number, and wherein the graphical user interface includes the graphical port with a graphical port number that is different than the device port number.

11. The IHS of claim 9, wherein the port monitoring engine is configured to:
determine that the device port is aggregated with a at least one other device port on the networking device; and
provide, on the display device, the graphical user interface with an indication that the graphical port is aggregated with at least one other graphical port.

12. The IHS of claim 8, wherein the port monitoring engine is configured to:
receive, using the wireless communication subsystem, the port indicator data that includes respective sub-port indicator data that is associated with the operation of each of a plurality of device sub-ports that are coupled to the device port; and
provide, on the display device, the graphical user interface including respective graphical sub-port indicators that correspond to each of the plurality of device sub-ports and that operate according to the respective sub-port indicator data.

13. The IHS of claim 8, wherein the port monitoring engine is configured to:
receive, using the wireless communication subsystem, first port indicator data from the networking device that is associated with a first operation of the device port, wherein the first port indicator data is configured to provide a port indicator that is associated with the device port on the networking device with a first color; and
use the first port indicator data associated with the first operation of the device port to provide, on the display device, the graphical user interface including the graphical port indicator with a second color that is different than the first color.

14. The IHS of claim 8, wherein the port monitoring engine is configured to:
determine that the device port is a part of a first virtual switch; and
provide, on the display device, an indication of the first virtual switch.

15. A method for monitoring ports, comprising:
receiving, wirelessly by a monitoring device from a networking device, port indicator data that is associated with the operation of a device port on the networking device;
determining, by the monitoring device, that a timestamp on the port indicator data satisfies a timing requirement for displaying a port indication; and
providing, by the monitoring device for display in response to the timestamp on the port indicator data satisfying the timing requirement, a graphical user interface that includes a graphical port indicator that operates according to the port indicator data.

16. The method of claim 15, wherein the graphical user interface includes a graphical port that corresponds to the device port.

17. The method of claim 16, wherein the device port on the networking device is associated with a device port number, and wherein the graphical user interface includes the graphical port with a graphical port number that is different than the device port number.

18. The method of claim 15, further comprising:
determining, by the monitoring device, that the device port is aggregated with a at least one other device port on the networking device; and
providing, by the monitoring device for display, the graphical user interface with an indication that the graphical port is aggregated with at least one other graphical port.

19. The method of claim 15, further comprising:
receiving, wirelessly by the monitoring device from the networking device, the port indicator data that includes respective sub-port indicator data that is associated with the operation of each of a plurality of device sub-ports that are coupled to the device port; and
providing, by the monitoring device for display in response to the timestamp on the port indicator data satisfying the timing requirement, the graphical user interface including respective graphical sub-port indicators that correspond to each of the plurality of device sub-ports and that operate according to the respective sub-port indicator data.

20. The method of claim 15, further comprising:
receiving, wirelessly by the monitoring device from the networking device, first port indicator data from the networking device that is associated with a first operation of the device port, wherein the first port indicator data is configured to provide a port indicator that is associated with the device port on the networking device with a first color; and
using the first port indicator data associated with the first operation of the device port to provide, by the monitoring device for display in response to the timestamp on the port indicator data satisfying the timing requirement, the graphical user interface including the graphical port indicator with a second color that is different than the first color.
